(19) United States
(12) Patent Application Publication
(10) Pub. No.: US 2019/0183725 A1
(43) Pub. Date: Jun. 20, 2019

(54) VIBRATIONAL REHABILITATION DEVICE

(71) Applicant: Chung-Fu Chang, Changhua County (TW)

(72) Inventor: Chung-Fu Chang, Changhua County (TW)

(21) Appl. No.: 15/846,476

(22) Filed: Dec. 19, 2017

(51) Int. Cl. A61H 23/02; A61H 1/00; A61H 23/00; A63B 21/00; A63B 21/22; A63B 23/035; B06B 1/16; H02K 7/06

(52) U.S. Cl. CPC A61H 23/0263; B06B 2201/76; A61H 23/004; A63B 21/00178; A63B 21/22; A63B 21/4034; A63B 21/4035; A63B 21/4049; A63B 23/0355; A63B 21/00181; B06B 1/167; H02K 7/061; A61H 2201/0165; A61H 2201/1261; A61H 2201/1635; A61H 2201/164; A61H 2201/1671; A63B 2213/00; A61H 2201/1215; A61H 1/008

(57) ABSTRACT

A vibrational rehabilitation device includes two drive assemblies, an eccentric assembly, and two half housings. Each drive assembly includes a driving wheel assembly and a driven wheel assembly. The driving wheel assembly has a driving wheel and a driving shaft. The driving shaft is mounted to a center of the driving wheel. A grip member is provided at one side of the driving shaft opposite the driving wheel. The driven wheel assembly includes a first driven wheel and a second driven wheel. The first driven wheel is connected with the driving wheel and driven by the driving wheel. The second driven wheel is coaxially disposed with the first driven wheel. The eccentric assembly includes two transmission wheels at two sides thereof and an eccentric block sandwiched between the two transmission wheels. The drive assemblies and the eccentric assembly are mounted in the housings.

### FIELD OF THE INVENTION

The present invention relates to a rehabilitation device, and more particularly, to a vibrational rehabilitation device.

### BACKGROUND OF THE INVENTION

For the elderly or stroke patients, how to move the fingers, toes and the other body parts is very important, especially in their early stages. Limbs rehabilitation enables the elderly or patients to restore their reactions as soon as possible, so that the other parts of the body can act flexibly.

General rehabilitation activities, for example, can be used to train standing stances and body stability through a standing table; throwing sandbags is to train body balance and shifting the center of gravity; the hand-ladder activity and the stacking of the blocks can be used to increase the degree of joint motion and prevent shoulder joint dislocation and train simple finger movements; the turning and shifting of OT chess can be used to train finger movements; picking beans and wearing beads can train hand-eye coordination and the sensitivity of the fingers. In addition, the guidance of transposing skills, the training of washing up and bathing skills and the use of tools and the like are all important items.

However, the aforesaid rehabilitation exercises may be inadequate because of the fact that the nerves at various parts of the body are not adequately stimulated. In some of the literature, it has been documented that stimulating the body can enhance the response to limb movements, which helps the elderly or patients to restore as soon as possible, avoids muscle relaxation, atrophy and degeneration, helps patients loose bones and joints, and reduces limb stiffness.

Accordingly, the inventor of the present invention has devoted himself based on his many years of practical experiences to solve these problems.

### SUMMARY OF THE INVENTION

The primary object of the present invention is to provide a vibrational rehabilitation device. Through a pair of drive assemblies staggered left and right, the user holds the grip members of the drive assemblies to make the drive assemblies rotate and generate regular vibrations, so that the rehabilitation exercise has a strong stimulation, there improving the rehabilitation effect.

In order to achieve the aforesaid object, the vibrational rehabilitation device of the present invention comprises two drive assemblies staggered left and right, an eccentric assembly, and two half housings to accommodate the drive assemblies.

The drive assemblies each include a driving wheel assembly and a driven wheel assembly. The driving wheel assembly has a driving wheel and a driving shaft. The driving shaft is mounted to a center of the driving wheel. A grip member is provided at one side of the driving shaft opposite the driving wheel. The driven wheel assembly includes a first driven wheel and a second driven wheel. The first driven wheel is connected with the driving wheel and driven by the driving wheel. The second driven wheel is coaxially disposed with the first driven wheel.

The eccentric assembly includes two transmission wheels at two sides thereof and an eccentric block sandwiched between the two transmission wheels.

The housings each have a mounting space therein. The drive assemblies and the eccentric assembly are mounted in the housings. The driving shaft extends out of a corresponding one of the housings. The grip member is located at an outer side of the corresponding housing.

Through the above structure, the drive assemblies are staggered left and right. When the user holds the grip members at the outer sides of the two half housings to exert a force to rotate the driving shafts, the drive assemblies drive the eccentric assembly to rotate. The eccentric block in the mounting space can generate uneven vibrations, so that the user's hand can feel strong vibrations to stimulate the hand. The strong vibrations can stimulate the user's brain, thereby increasing the rehabilitation effect.

In an embodiment of the present invention, the housings each have a through hole. The through hole is mounted with a bearing. The driving shaft is inserted through the bearing to extend out of the corresponding housing. The grip member is connected to the driving shaft. Thereby, the bearing can eliminate the radial load generated by the driving shaft.

In an embodiment of the present invention, the eccentric block of the eccentric assembly is assembled to the driven wheel, so that the rotation of the driven wheel can increase the vibrations.

According to another aspect of the present invention, a vibrational rehabilitation device is provided. The vibrational rehabilitation device comprises a central support frame, two drive assemblies staggered left and right, and an eccentric assembly. The central support frame is provided with two bearings. Driving shafts of the drive assemblies are inserted through the bearings, respectively. The drive assemblies each include a driving wheel, a first driven wheel, and a second driven wheel. The driving wheel is connected to the first driven wheel. The first driven wheel and the second driven wheel are connected through a connecting shaft. A crank and a pedal are provided at an outer side of each of the driving shafts of the drive assemblies. By rotating the pedal and the crank, the driving shafts are rotated. The eccentric assembly is connected to the second driven wheel. Through this embodiment, the pedals are rotated and applied with a force by the user's hands or feet so that the cranks indirectly drive the drive assemblies to rotate through the driving shafts and the force is transmitted to the eccentric assembly for the overall structure to generate vibrations. Thereby, this embodiment can assist in fully exercising and stimulating the limbs for the elderly who are weak in hands and feet or for patients to be rehabilitated. In the aforesaid structure, the eccentric assembly includes a connecting wheel. An eccentric block is provided on the connecting wheel for generating regular swings when rotated. In addition, the outer diameter of the connecting wheel is less than that of the driven wheel connected to the connecting wheel, so that the connecting wheel is rotated faster and faster and the vibration frequency is higher.

In the aforesaid embodiment, the driving shaft of the driving wheel is provided with a motor. The motor drives the drive assemblies to rotate the eccentric assembly. For a user who just beings to rehabilitate, the vibrational rehabilitation device of the present invention not only increases his/her confidence but also helps the limbs to do rehabilitation exercises.

### BRIEF DESCRIPTION OF THE DRAWINGS

FIG. 1 is a perspective view of the present invention;

FIG. 2 is a schematic view of the present invention when in use;

FIG. 3 is an exploded view of the present invention;

FIG. 4 is a schematic view of the eccentric block of the present invention;

FIG. 5 is a schematic view showing the operation of the present invention;

FIG. 6 is a schematic view of another embodiment of the present invention;

FIG. 7 is a schematic view of an implementation of the present invention mounted with pedals and cranks;

FIG. 8 is a schematic view of an implementation of the present invention mounted with a motor; and

FIG. 9 is a schematic view of an implementation of the present invention mounted with a linkage mechanism.

FIG. 9a is the left side view of FIG. 9.

FIG. 9b is the right side view of FIG. 9.

### DETAILED DESCRIPTION OF THE PREFERRED EMBODIMENTS

Embodiments of the present invention will now be described, by way of example only, with reference to the accompanying drawings.

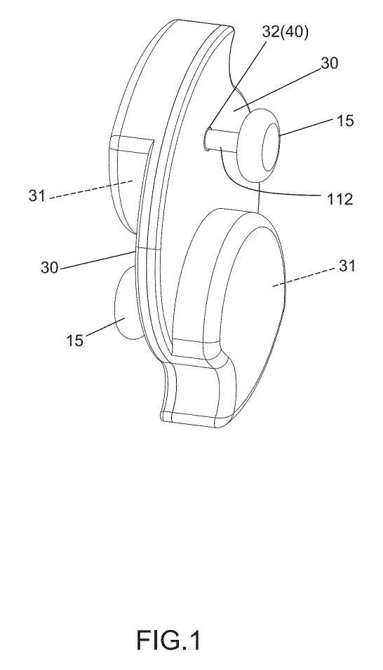

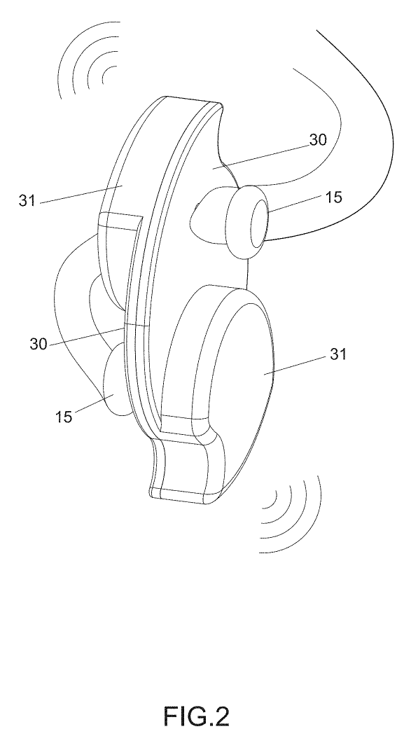

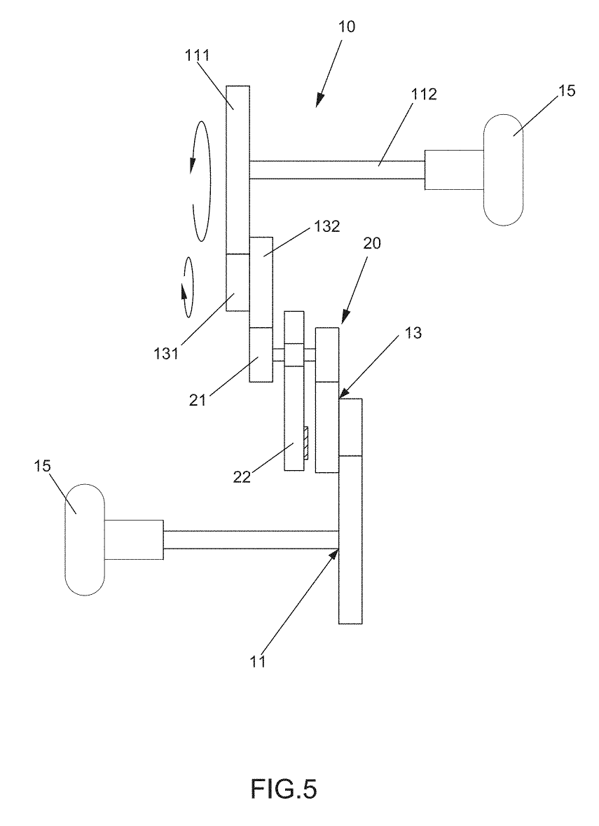

Referring to FIG. 1 to FIG. 5, a vibrational rehabilitation device according to a first embodiment of the present invention comprises two drive assemblies 10 staggered left and right, an eccentric assembly 20, and two half housings 30 to accommodate the drive assemblies 10.

Referring to FIG. 1 to FIG. 5, the drive assemblies 10 are staggered left and right. Each drive assembly 10 includes a driving wheel assembly 11 and a driven wheel assembly 13. The driving wheel assembly 11 has a driving wheel 111 and a driving shaft 112. The driving shaft 112 is mounted to the center of the driving wheel 111. A grip member 15 is provided at one side of the driving shaft 112 opposite the driving wheel 111. The driven wheel assembly 13 includes a first driven wheel 131 and a second driven wheel 132. The first driven wheel 131 is connected with the driving wheel 111 and driven by the driving wheel 111. The second driven wheel 132 is coaxially disposed with the first driven wheel 131. In the present invention, the driving wheel assembly 11 and the driven wheel assembly 13 may adopt a gear meshing transmission, a pulley drive, or a chain and a sprocket transmission.

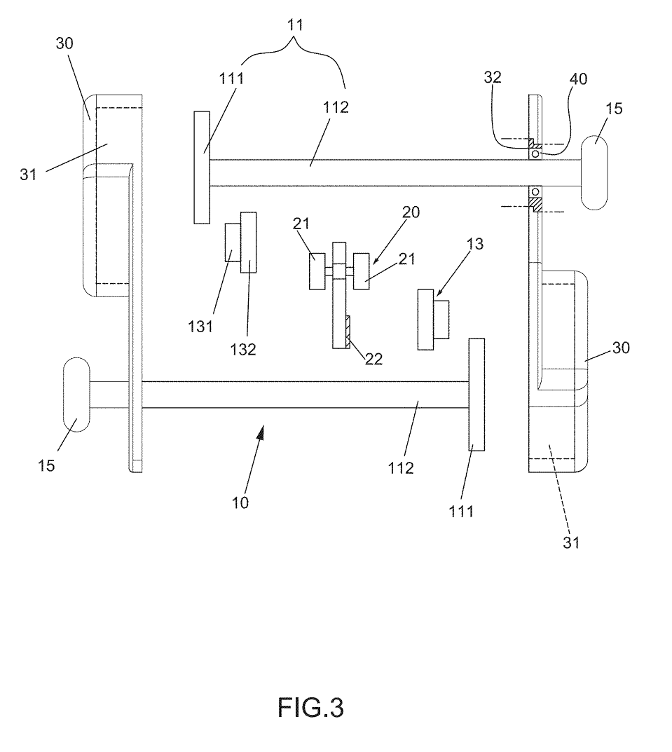

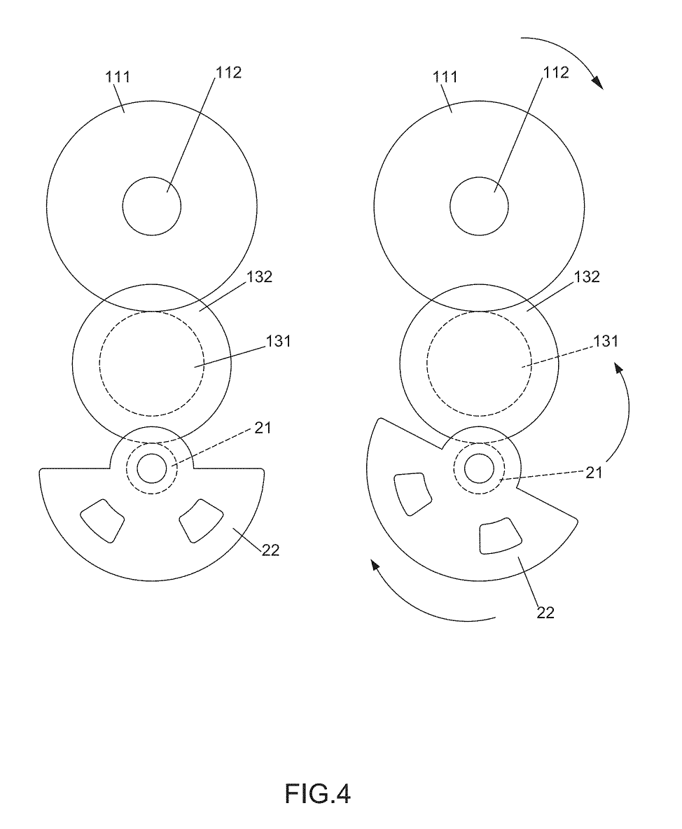

Referring to FIG. 3 to FIG. 4, the eccentric assembly 20 includes two transmission wheels 21 at two sides thereof and an eccentric block 22 sandwiched between the two transmission wheels 21. As shown in FIG. 4, the eccentric block 22 has a semicircular shape. When rotating, the whole structure can generate regular swings. Under the swing of the eccentric block 22, the overall structure can generate vibrations.

As shown in FIG. 1 to FIG. 3, the housing 30 may made of a plastic or lightweight material. In the first embodiment, the housing 30 has a swirl shape. The housing 30 has a mounting space 31 therein. The drive assemblies 10 and the eccentric assembly 20 are mounted in the housings 30. The driving shaft 112 extends out of the housing 30. The grip member 15 is located at an outer side of the corresponding housing 30. The housing 30 has a through hole 32. The through hole 32 is mounted with a bearing 40. The driving shaft 112 is inserted through the bearing 40 to extend out of the housing 30. Thereby, the bearing 40 can eliminate the radial load generated by the driving shaft 112.

Through the above structure, the present invention is used in the following manner. The drive assemblies 10 are staggered left and right. When the user holds the grip members 15 at the outer sides of the two half housings 30 to exert a force to rotate the driving shafts 112, the drive assemblies 10 drive the eccentric assembly 20 to rotate. The eccentric block 22 in the mounting space 31 can generate uneven vibrations, so that the user's hand can feel strong vibrations to stimulate the hand. The strong vibrations can stimulate the user's brain, thereby increasing the rehabilitation effect.

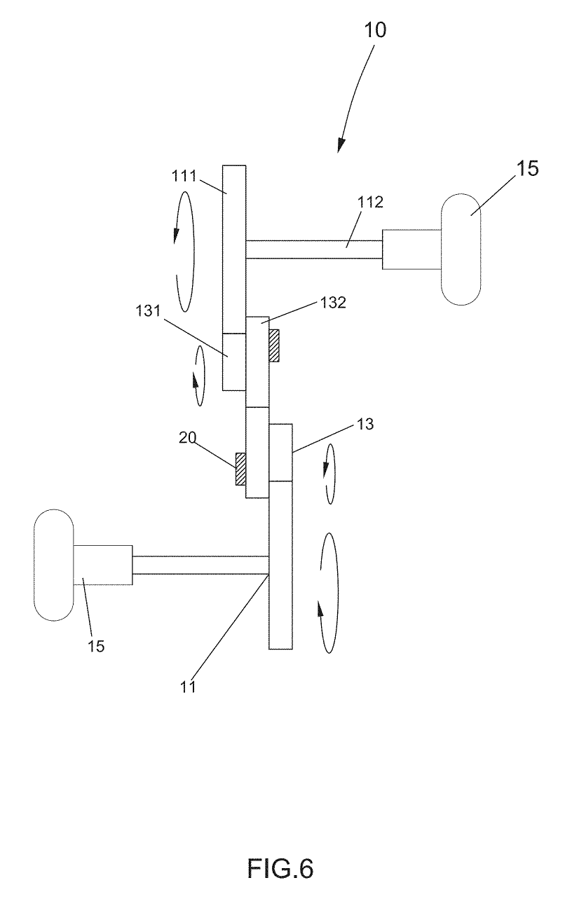

Please refer to FIG. 6, which is a variation of the first embodiment. The eccentric block 22 of the eccentric assembly 20 is assembled to the driven wheel, so that the rotation of the driven wheel can increase the vibrations.

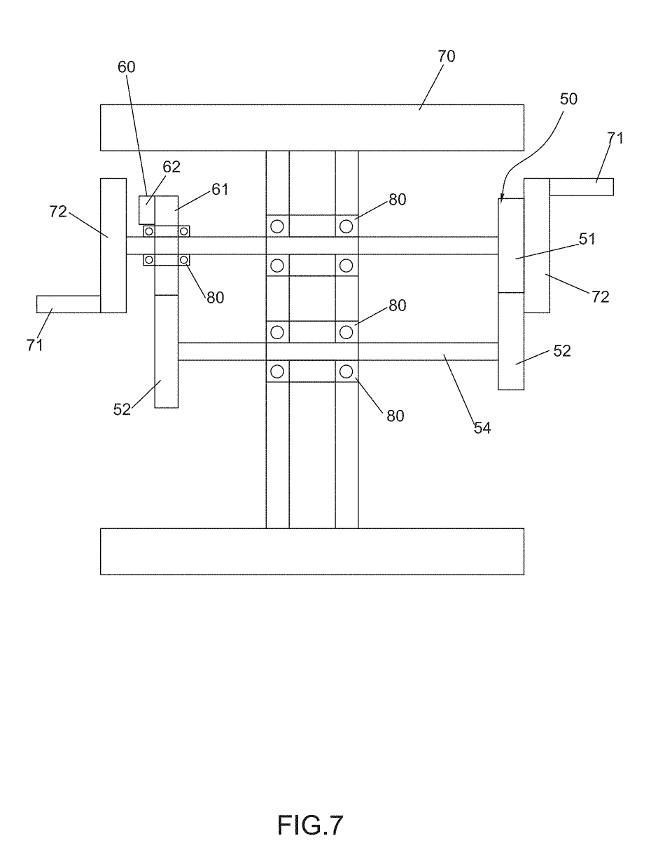

FIG. 7 illustrates a second embodiment of the present invention, which is based on the concept of the first embodiment. A drive assembly 50 is fixed to a central support seat 70. The central support seat 70 may be a horizontal housing or a vertical housing. The structure of this embodiment is described hereinafter. This embodiment comprises a central support frame, two drive assemblies 50 staggered left and right, and an eccentric assembly 60. The central support frame is provided with two bearings 80. Driving shafts 54 of the drive assemblies 50 are inserted through the bearings 80, respectively. Each drive assembly 50 includes a driving wheel 51, a first driven wheel 52, and a second driven wheel 53. The driving wheel 51 is connected to the first driven wheel 52. The first driven wheel 52 and the second driven wheel 53 are connected through a connecting shaft 55. A crank 72 and a pedal 71 are provided at an outer side of the driving shaft 54 of each drive assembly 50. By rotating the pedal 71 and the crank 72, the driving shaft 54 is rotated. The eccentric assembly 60 is connected to the second driven wheel 53.

Through the second embodiment, the pedals 71 are rotated and applied with a force by the user's hands or feet so that the cranks 72 indirectly drive the drive assemblies 50 to rotate through the driving shafts 54, and the force is transmitted to the eccentric assembly 60 for the overall structure to generate vibrations. Thereby, the present embodiment can assist in fully exercising and stimulating the limbs for the elderly who are weak in hands and feet or for patients to be rehabilitated.

As shown in FIG. 7, the eccentric assembly 60 includes a connecting wheel 61. An eccentric block 62 is provided on the connecting wheel 61 for generating regular swings when rotated. In addition, the outer diameter of the connecting wheel 61 is less than that of the driven wheel connected to the connecting wheel 61, so that the connecting wheel 61 is driven by the second driven wheel 53 to rotate. The speed is faster and faster, and the vibration frequency is higher.

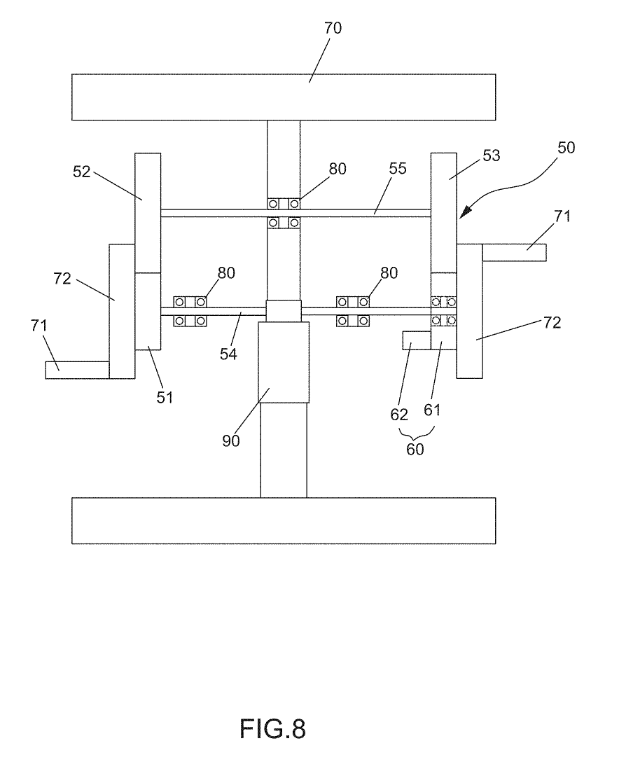

Please refer to FIG. 8, which is a variation of the second embodiment. The driving shaft 54 of the driving wheel 51 is provided with a motor 90. The motor 90 drives the drive assemblies 50 to rotate the eccentric assembly 60. For a user who just beings to rehabilitate, the vibrational rehabilitation device of the present invention not only increases his/her confidence but also helps the limbs to do rehabilitation exercises. In addition, the right pedal 71 and the crank 72 are coupled with the connecting wheel 61.

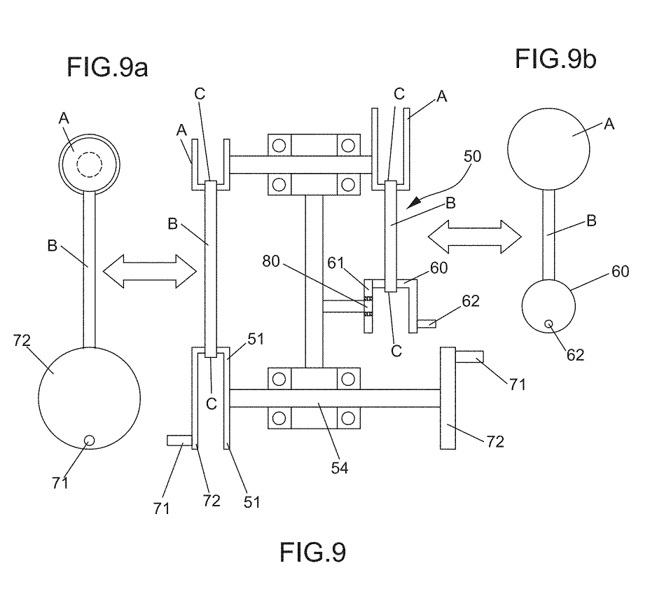

FIG. 9, 9a, 9b, in which FIG. 9 is a top view of another implementation of the second embodiment. In this embodiment, the drive assembly 50 is disposed on a central support frame (not shown). A pivot seat A is provided above the central support frame. The pedal 71 and the crank 72 drive the driving wheel 51 to further drive the pivot seat A. The pivot seat A is connected with a link shaft B. The link shaft B can drive the connecting wheel 61, and the connecting wheel 61 is used to drive the eccentric assembly 60, so that the overall structure also generates vibrations. The pivot seat A and the link shaft B are coupled through a buckle ring.

In addition to be used for the elderly or those who need rehabilitation, the present invention can also be used in a gym or at home. Because of its small size and convenient storage, the present invention is suitable for use in a small house. Through the vibration, the prevent invention can provide a better exercise effect for some body parts, such as thighs, arms, and so on.

Although particular embodiments of the present invention have been described in detail for purposes of illustration, various modifications and enhancements may be made without departing from the spirit and scope of the present invention. Accordingly, the present invention is not to be limited except as by the appended claims.

1. A vibrational rehabilitation device, comprising two drive assemblies staggered left and right, an eccentric assembly, and two half housings to accommodate the drive assemblies;
the drive assemblies each including a driving wheel assembly and a driven wheel assembly, the driving wheel assembly having a driving wheel and a driving shaft, the driving shaft being mounted to a center of the driving wheel, a grip member being provided at one side of the driving shaft opposite the driving wheel, the driven wheel assembly including a first driven wheel and a second driven wheel, the first driven wheel being connected with the driving wheel and driven by the driving wheel, the second driven wheel being coaxially disposed with the first driven wheel;
the eccentric assembly including two transmission wheels at two sides thereof and an eccentric block sandwiched between the two transmission wheels; the housings each having a mounting space therein, the drive assemblies and the eccentric assembly being mounted in the housings, the driving shaft extending out of a corresponding one of the housings, the grip member being located at an outer side of the corresponding housing.

2. The vibrational rehabilitation device as claimed in claim 1, wherein the housings each have a through hole, the through hole is mounted with a bearing, the driving shaft is inserted through the bearing to extend out of the corresponding housing, and the grip member is connected to the driving shaft.

3. A vibrational rehabilitation device, comprising a central support frame, two drive assemblies staggered left and right, and an eccentric assembly, the central support frame is provided with two bearings, driving shafts of the drive assemblies being inserted through the bearings respectively, the drive assemblies each including a driving wheel, a first driven wheel and a second driven wheel, the driving wheel being connected to the first driven wheel, the first driven wheel and the second driven wheel being connected through a connecting shaft, a crank and a pedal being provided at an outer side of each of the driving shafts of the drive assemblies, by rotating the pedal and the crank, the driving shafts being rotated, the eccentric assembly being connected to the second driven wheel.

4. The vibrational rehabilitation device as claimed in claim 3, wherein the eccentric assembly includes a connecting wheel, an eccentric block is provided on the connecting wheel for generating regular swings when rotated.

5. The vibrational rehabilitation device as claimed in claim 3, wherein the connecting wheel has an outer diameter less than that of the second driven wheel connected to the connecting wheel.

6. The vibrational rehabilitation device as claimed in claim 3, wherein the driving shaft is provided with a motor, and the motor drives the drive assemblies to rotate the eccentric assembly.

7. The vibrational rehabilitation device as claimed in claim 1, wherein the drive assembles are disposed on a central support frame, a pivot seat is provided above the central support frame, a pedal and a crank drive the driving wheel to further drive the pivot seat, the pivot seat is connected with a link shaft, the link shaft drives a connecting wheel, and the connecting wheel is used to drive the eccentric assembly.

8. The vibrational rehabilitation device as claimed in claim 1, wherein the drive assemblies use a pulley drive.

9. The vibrational rehabilitation device as claimed in claim 3, wherein the drive assemblies use a pulley drive.

10. The vibrational rehabilitation device as claimed in claim 1, wherein the drive assemblies use a chain and a sprocket transmission.

11. The vibrational rehabilitation device as claimed in claim 3, wherein the drive assemblies use a chain and a sprocket transmission.

12. The vibrational rehabilitation device as claimed in claim 1, wherein the drive assemblies use a gear meshing transmission.

13. The vibrational rehabilitation device as claimed in claim 3, wherein the drive assemblies use a gear meshing transmission.
